(19) United States
(12) Patent Application Publication
(10) Pub. No.: US 2011/0149451 A1
(43) Pub. Date: Jun. 23, 2011

(54) ELECTROSTATIC PROTECTION METHOD AND DEVICE FOR PRODUCTION LINE

(75) Inventor: Ching-Feng Hsieh, Taipei (TW)

(73) Assignee: ASKEY COMPUTER CORP., Taipei (TW)

(21) Appl. No.: 12/694,569

(22) Filed: Jan. 27, 2010

(30) Foreign Application Priority Data
Dec. 17, 2009 (TW) 098143438

(51) Int. Cl. H02H 9/00; B23P 11/00

(52) U.S. Cl. 361/56; 29/428

(57) ABSTRACT

The electrostatic protection device for using in the production lines is provided with at least two circuits on production line. The production line is connected to a grounding end via a first circuit and configured to release static electricity. The production line is connected to the grounding end via a second circuit. Once a production line gives a feedback to indicate that static electricity cannot be released from the production line through the first circuit, and the second circuit will instantly give a failure warning. The feedback mechanism for electrostatic protection works without performing any automated detection operation on the production line. Hence, electrostatic protection provided by the electrostatic protection method and device is advantageously characterized by giving an alert to warn of static electricity release failure efficiently and instantly.

### CROSS-REFERENCE TO RELATED APPLICATIONS

This non-provisional application claims priority under 35 U.S.C. §119(a) on Patent Application No(s). 098143438 filed in Taiwan, R.O.C. on 17 Dec. 2009, the entire contents of which are hereby incorporated by reference.

### FIELD OF THE INVENTION

The present invention relates to electrostatic protection methods and devices, and more particularly, to an electrostatic protection method and device using in the production line.

### BACKGROUND OF THE INVENTION

In addition to the clean room fabrication requirement, another important requirement for assembling the electronic products is electrostatic protection in the production line. In general, a microscale or nanoscale chip is integrally assembled to an electronic product. The human body can generate kilovolts or ten thousands of kilovolts of static electricity that directly affects on those microscale/nanoscale chips severely. The high voltage breakdowns or damages the electronic products and reduces the yield rate thereof, and in consequence the production line will be incurred a great loss.

According to the prior art, the electronic product assembly workers at work wear antistatic wrist straps for eliminating the static electricity generated by the human body. The antistatic wrist straps are grounded via an electrostatic protection device in order to eliminate the static electricity. However, due to the change of the operation in the production line, the antistatic line of the production line is altered or relocated, or any change in the production line will result the antistatic line being altered, broken circuit the circuit of the electrostatic protection device and the ground will be broken which will cause the static electricity cannot be efficiently eliminated by the electrostatic protection device. The result of the broken circuit is not immediately discovered by users.

A conventional way of mitigating the adverse effect of imperceptibility of the broken circuit of the antistatic line measuring a production line by a multimeter at a specific time so as to decrease the chance that electronic products are damaged due to static electricity arising from the broken circuit. However, a plurality of production lines, which are concurrently operating are difficult to measure separately and frequently. Hence, tremendous damage done to the electronic products by static electricity cannot be timely eliminated, unless the broken circuit of the electrostatic protection device is instantly discovered. To address the aforesaid problem, Taiwan Patent No. M307113 proposes an automatic monitoring alert device for monitoring the ground resistance of a plurality of points of grounding. The automatic monitoring alert device comprises a plurality of monitoring ports parallel-connected, via monitoring lines, to the plurality of points of grounding being monitored, respectively. Operation of the monitoring ports is individualized by varying the allowable range of the ground resistance of individual ones of the monitoring ports according to an object to be detected and varying the way of giving an alert after a monitoring operation reveals that the ground resistance falls outside the allowable range thereof.

The automatic monitoring alert device of the Taiwan Patent No. M307113 comprises a processing unit and a measuring unit operating under the control of the processing unit. Operation of the measuring unit involves: measuring regularly the ground resistance of the plurality of points of grounding with the plurality of monitoring ports; examining the points of grounding one by one with the processing unit; and giving an alert by display and operation units upon detection of abnormality. Nonetheless, it is impossible to detect static electricity instantly by the aforesaid way of detection, not to mention that static electricity will not be detected unless and until a detection operation is automatically carried out.

### SUMMARY OF THE INVENTION

It is an objective of the present invention to provide an electrostatic protection method for use with a production line to provide electrostatic protection for the production line and give an alert without undertaking any detection operation.

Another objective of the present invention is to provide an electrostatic protection device configured for using in a production line, disposed on the production line, and configured to provide electrostatic protection for the production line and capable of sending a failure warning.

To achieve the above and other objective, the present invention provides an electrostatic protection method for using in a production line, comprising the steps of: (i) building on a production line at least a first electrostatic conductive element for external connection with at least a second electrostatic conductive element; (ii) connecting the first electrostatic conductive element and a grounding end to form a first circuit for releasing static electricity from the first electrostatic conductive element; (iii) connecting an alert device, the first electrostatic conductive element, and the grounding end, wherein the alert device is provided therein with a second circuit for giving a failure warning of static electricity release failure; and (iv) giving feedback on failure of the first electrostatic conductive element to release static electricity through the first circuit to trigger the second circuit.

To achieve the above and other objective, the present invention provides an electrostatic protection device for use with a production line. The electrostatic protection device comprises a first electrostatic conductive element and an alert device. The first electrostatic conductive element is connected to a grounding end and externally connected to at least a second electrostatic conductive element. The first electrostatic conductive element and the grounding end are connected together to form a first circuit for releasing static electricity from the first electrostatic conductive element. The alert device is electrically connected to the first electrostatic conductive element and the grounding end and provided therein with a second circuit to give a failure warning of static electricity release failure when it is triggered in response to a feedback on failure of the first electrostatic conductive element to release static electricity.

In an embodiment, the alert device further comprises a control unit, an alert unit, and a power supply unit. The control unit is connected to the second circuit and configured to respond to static electricity release failure and triggered the second circuit. The alert unit is connected to the second circuit and configured to give a failure warning of static electricity release failure. The power supply unit is connected to the second circuit and configured to supply electric power to the alert device.

To achieve the above and other objective, the present invention provides an electrostatic protection device for using in a plurality of production line, comprising: a plurality of first electrostatic conductive elements corresponding in position to the production lines respectively, and connected to a grounding end, and externally connected to at least a second electrostatic conductive element, wherein each of the first electrostatic conductive elements and the grounding end are connected to form a first circuit for releasing static electricity from the first electrostatic conductive elements; and an alert device provided therein with a plurality of second circuits corresponding in position to the production lines respectively, wherein each of the second circuits, the corresponding first electrostatic conductive element and the grounding end are electrically connected together, in which the alert device gives a feedback on failure of releasing the static electricity from the corresponding first electrostatic conductive element in the corresponding production line, resulted in triggering the corresponding second circuits to give a failure warning of static electricity release failure.

In an embodiment, the alert device further comprises a plurality of control units, a plurality of alert units, and a power supply unit. The control units are connected to the second circuits corresponding in position to the production lines, respectively, and configured to respond to static electricity release failure on a corresponding one of the production lines and trigger the second circuits. The alert units are connected to the second circuits corresponding in position to the production lines, respectively, and configured to give a failure warning of static electricity release failure. The power supply unit is connected to the second circuits corresponding in position to the production lines, respectively, and configured to supply electric power to the alert device.

An electrostatic protection method and device for using in a production line according to the present invention enable an instant response, without undertaking any detection operation, to the condition of electrostatic protection provided by a first electrostatic conductive element (such as, a production line static electricity common bus) connected to the ground or a plurality of second electrostatic conductive elements (such as electrostatic wrist straps) connected to the ground, give a failure warning to indicate that the electrostatic protection is failed, and enable the users to efficiently eliminate any damage otherwise arising from failure to provide real-time electrostatic protection for the production line.

### BRIEF DESCRIPTION OF THE DRAWINGS

FIG. 1 is a schematic view of an electrostatic protection method for using in a production line in accordance with a first embodiment of the present invention;

FIG. 2 is a schematic view of the electrostatic protection method for using in a production line in accordance with a second embodiment of the present invention;

FIG. 3a and FIG. 3b are block diagrams of an electrostatic protection device for using in the production line in accordance with the first embodiment of the present invention;

FIG. 3c is a block diagram of the electrostatic protection device for using in the production line in accordance with the second embodiment of the present invention;

FIG. 4a and FIG. 4b are circuit diagrams of the electrostatic protection device for using in the production line in accordance with the second embodiment of the present invention; and

FIG. 5a and FIG. 5b are block diagrams of an electrostatic protection device for using in a plurality of production lines in accordance with a third embodiment of the present invention.

### DETAILED DESCRIPTION OF THE EMBODIMENTS

The objectives, features and advantages of the present invention are described in detail hereunder to enable persons skilled in the art to gain insight into the present invention with reference made to the embodiments described hereunder and the accompanying drawings.

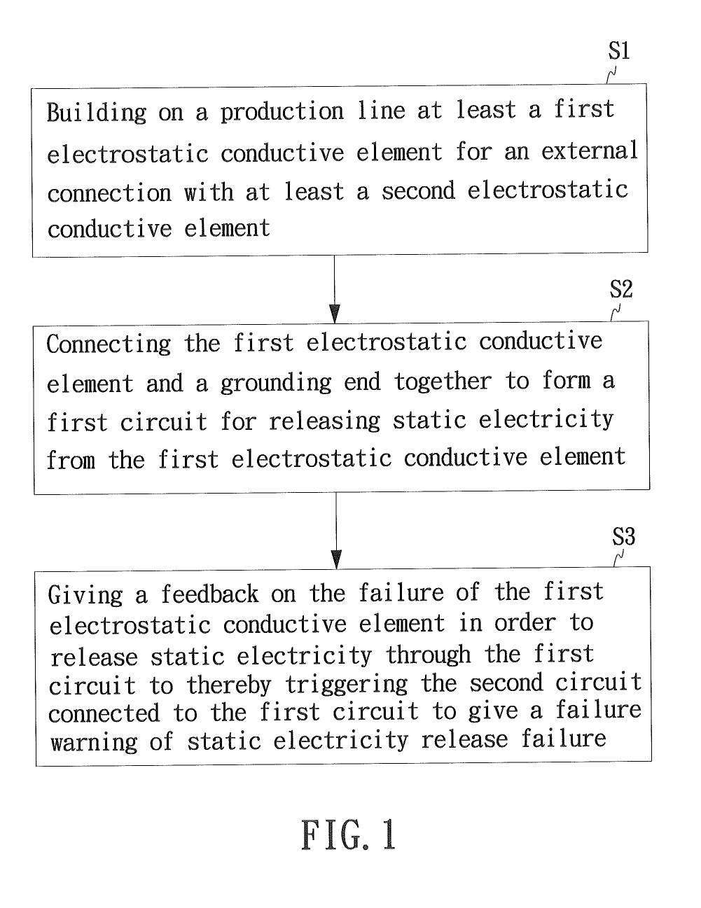

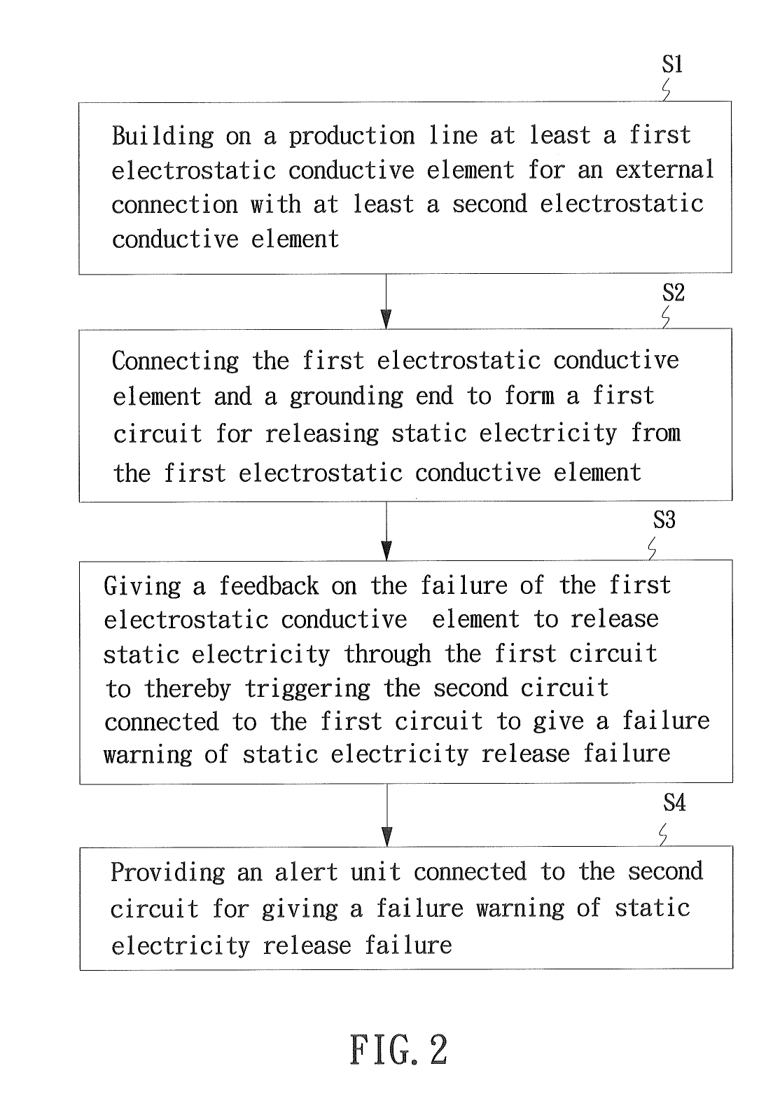

Referring to FIG. 1, a schematic view of an electrostatic protection method for using in a production line in a first embodiment of the present invention. As shown in the drawing, the electrostatic protection method for using in the production line comprises the steps of: (step S1) building on a production line at least a first electrostatic conductive element for external connection with at least a second electrostatic conductive element, wherein the first electrostatic conductive element is a production line static electricity common bus, and the second electrostatic conductive elements are antistatic wrist straps; (step S2) connecting the first electrostatic conductive element and a grounding end to form a first circuit for releasing static electricity from the first electrostatic conductive element; (step S3) connecting an alert device, the first electrostatic conductive element, and the grounding end, wherein the alert device is provided therein with a second circuit for giving a failure warning of static electricity release failure; and (step S4) giving a feedback on failure of the first electrostatic conductive element to release static electricity through the first circuit to thereby triggering the second circuit. Step S3 of the electrostatic protection method for using in the production line further comprises the steps of: (step S3a) providing the second circuit with a control unit for responding to the failure of the first circuit to release static electricity and triggering the second circuit; (step S3b) providing the second circuit with an alert unit for giving a failure warning of static electricity release failure after the second circuit is triggered; and (step S3c) providing the second circuit with a power supply unit for supplying electric power to the alert device. Referring to FIG. 2, the electrostatic protection method is demonstrated how the method is operated in the production line in accordance with a second embodiment of the present invention.

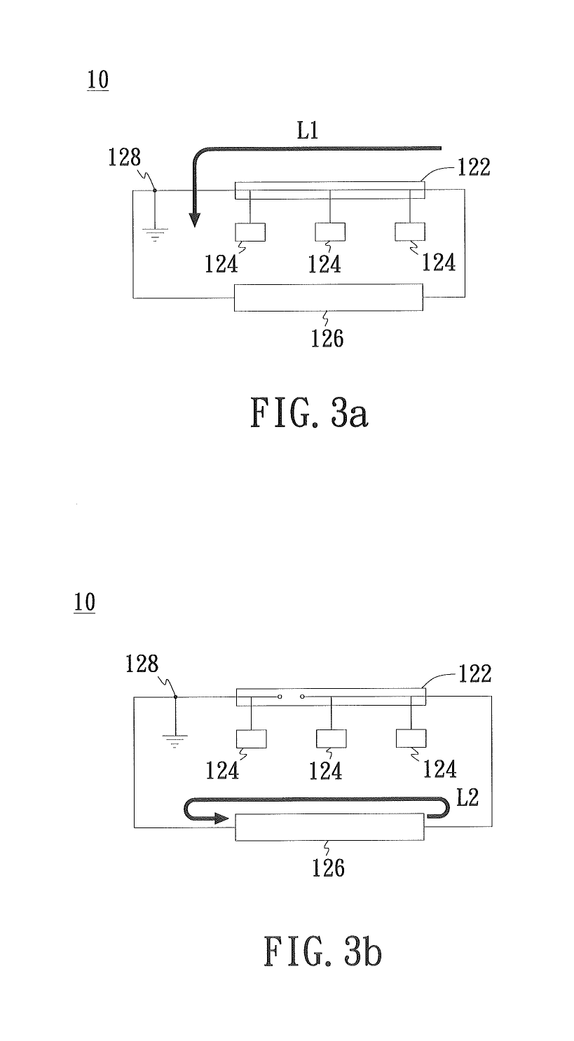

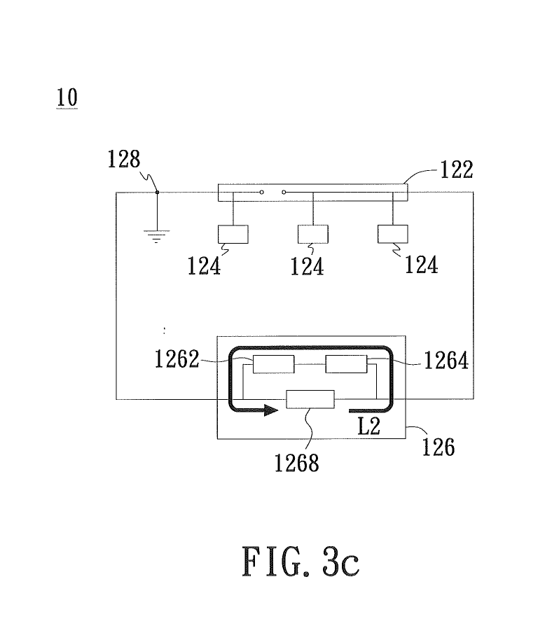

Referring to FIG. 3a and FIG. 3b, the block diagrams of an electrostatic protection device for using in a production line in a first embodiment of the present invention. As shown in FIG. 3a, an electrostatic protection device 10 is configured for using in the production line, and the electrostatic protection device 10 comprises a first electrostatic conductive element 122, a plurality of second electrostatic conductive elements 124, and an alert device 126. The second electrostatic conductive elements 124 transmit static electricity to the first electrostatic conductive element 122 connected to a grounding end 128. The other end of the grounding end 128 is connected to the ground for eliminating/releasing static electricity from the first electrostatic conductive element 122. The second electrostatic conductive elements 124 are separately connected to the first electrostatic conductive element 122. For instance, the second electrostatic conductive elements 124 are antistatic wrist straps, and the antistatic wrist straps are connected to a production line static electricity common bus (that is, the first electrostatic conductive element 122), thereby allowing the second electrostatic conductive elements 124 to be connected together. Preferably, the first electrostatic conductive element 122 and the grounding end 128 are connected together to form a first circuit L1 for releasing static electricity from the first electrostatic conductive element 122. The alert device 126 is electrically connected to the first electrostatic conductive element 122 and the grounding end 128. The alert device 126 is provided therein with a second circuit L2 and triggers the second circuit L2 to send out a failure warming to indicate that the static electricity is failed to release according to a feedback on the condition of static electricity released by the first circuit L1. The feedback on the condition of static electricity indicates that: a broken circuit is occurred between the first electrostatic conductive element 122 and the grounding end 128, as a result, the static electricity cannot be released through the grounding end 128, and thus the broken circuit of the first circuit L1 triggers the alert device 126 such that the second circuit L2 therein turns ON and a failure warning of static electricity release is sent out, thereby allowing the users to instantly perceive that an electrostatic protection failure has occurred to the production line, as shown in FIG. 3b.

Referring to FIG. 3c, there is shown a block diagram of the electrostatic protection device 10 for using in a production line according to a second embodiment of the present invention. As shown in the drawing, the alert device 126 comprises a control unit 1264, an alert unit 1262, and a power supply unit 1268, and all of which are positioned along the second circuit L2 as shown in FIG. 3c. The control unit 1264 is responsive to the broken circuit of the first circuit L1 and thus triggers the second circuit L2 to turn ON. The second circuit L2 connects the power supply unit 1268, the control unit 1264, and the alert unit 1262. After the second circuit L2 has turned ON, the alert unit 1262 instantly gives an alert to warn that static electricity release failure has happened to a production line. The alert unit 1262, which is an indicator or a buzzer, serves an alert purpose by generating a light alert, a sound alert, or a combination thereof.

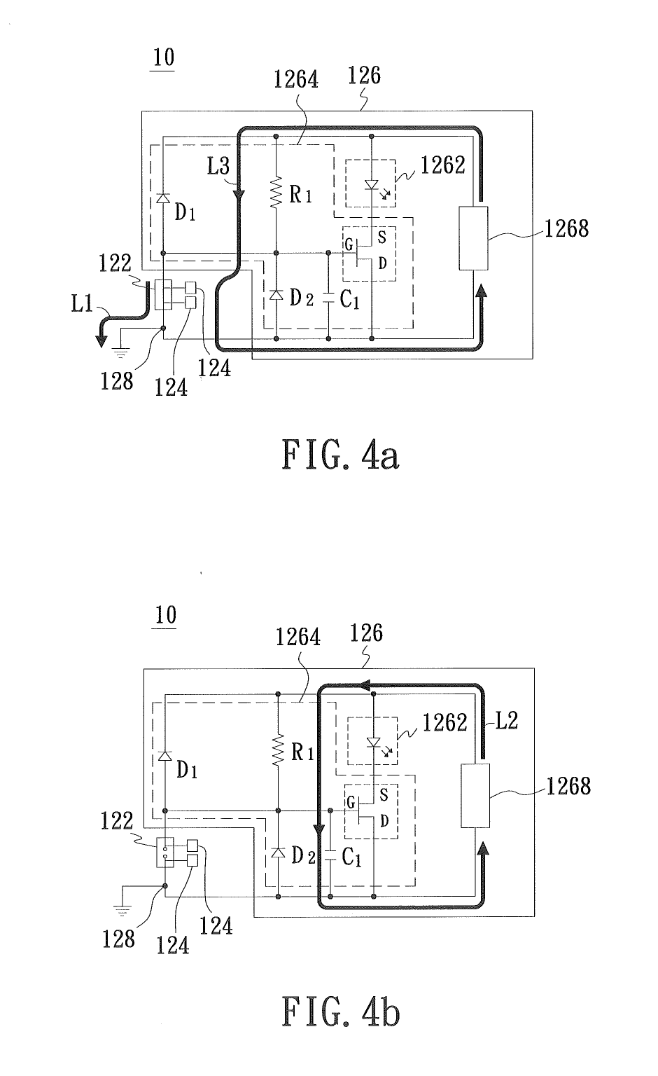

Referring to FIG. 4a and FIG. 4b, there are shown circuit diagrams of the electrostatic protection device for using in the production line in accordance with the second embodiment of the present invention. The first electrostatic conductive element 122 and the grounding end 128 of the electrostatic protection device 10 are connected to the ground, a casing, or a common reference voltage source. The first electrostatic conductive element 122 is connected to the second electrostatic conductive elements 124. The first electrostatic conductive element 122 and the grounding end 128 are connected together to form the first circuit L1 for releasing static electricity from the first electrostatic conductive element 122. The alert device 126 of the electrostatic protection device 10 comprises the alert unit 1262, the control unit 1264, and the power supply unit 1268. The alert device 126 is electrically connected to the first electrostatic conductive element 122 and the grounding end 128. In this embodiment, the alert device 126 comprises a three-terminal control element having an input end S, an output end D, and a control end G; in other words, the three-terminal control element is a p-type field-effect transistor (FET), an n-type field-effect transistor (FET), or a bipolar junction transistor (BJT). The alert unit 1262 is connected to the three-terminal control element. The three-terminal control element works in conjunction with a resistor R1, two diodes D1, D2, and a capacitor C1 and in accordance with the condition (such as the broken circuit) of the first circuit L1. The control end G of the three-terminal control element controllably allows the input end S to be connected to or disconnected from the output end D such that the alert unit 1262 gives feedback on the condition of static electricity released by the first circuit L1 by selectively giving an alert. The power supply unit 1268 is parallel-connected to the alert device 126 and supplies electric power to the alert unit 1262.

Referring to FIG. 4a, in the absence of a broken circuit between the first electrostatic conductive element 122 and the grounding end 128, static electricity can be released through the first circuit L1, and electric current from the power supply unit 1268 of the alert device 126 always chooses to pass through a circuit of the least resistance and thus passes through a third circuit L3 formed from the first electrostatic conductive element 122.

Referring to FIG. 4b, in the presence of a broken circuit between the first electrostatic conductive element 122 and the grounding end 128 and thus the absence of the first circuit L1, the electric current from the power supply unit 1268 passes through the resistor R1 and the capacitor C1 and charges the capacitor C1 to thereby increase the voltage difference between the control end G and the output end D of the three-terminal control element, allow the input end S to be connected to the output end D when the voltage difference reaches a predetermined level, and thus allow electric current to pass through the alert unit 1262, so as to achieving the alert purpose. The predetermined level of the voltage difference depends on the three-terminal control element, the resistor R1, and the capacitor C1 used. In the absence of the first circuit L1, the control unit 1264 of the three-terminal control element enables the second circuit L2 to be instantly triggered and thus give a failure warning to indicate that the static electricity is failed to release efficiently and instantly.

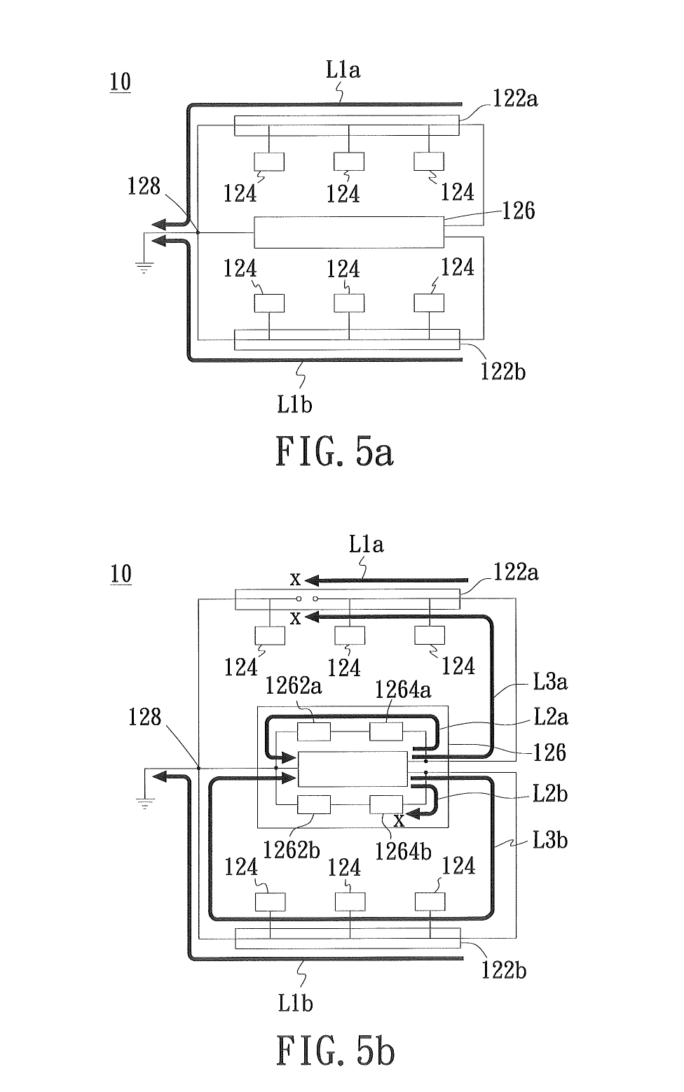

Referring to FIG. 5a and FIG. 5b, there are shown block diagrams of an electrostatic protection device for use with a plurality of production lines in a third embodiment of the present invention. The third embodiment is exemplified by two production lines. As shown in FIG. 5a, no broken circuit occurs to first electrostatic conductive elements 122a, 122b of the two production lines. As shown in FIG. 5b, a broken circuit occurs to the first electrostatic conductive element 122a of the first production line. As shown in FIG. 5a, in the absence of a broken circuit, the first electrostatic conductive elements 122a, 122b release static electricity through the first circuits L1a, L1b corresponding in position thereto, respectively. As shown in FIG. 5b, the first circuit L1a associated with a broken circuit no longer exists, and electric current from the power supply unit 1268 no longer passes through a third circuit L3a; hence, the alert device 126 gives instant feedback on the condition and triggers the second circuit L2a via a control unit 1264a, so as for an alert unit 1262a to give an alert.

The first circuit L1b not associated with a broken circuit continues to release static electricity, and electric current from the power supply unit 1268 chooses to pass through a third circuit L3b of relatively less resistance; hence, the second circuit L2b is not triggered, nor are a control unit 1264b or an alert unit 1262b actuated.

In the aforesaid embodiments, an electrostatic protection method and device of the present invention enable an instant response, without undertaking any detection operation, to the condition of electrostatic protection provided by a first electrostatic conductive element connected to the ground and applicable to a production line, give an alert to warn of electrostatic protection failure, and efficiently inform users of the current condition of electrostatic protection on the production line. The electrostatic protection method and device of the present invention is readily expandable to thereby effectuate an electrostatic protection system for use with a plurality of production lines, wherein a monitoring end provided at a fixed position monitors electrostatic protection on a plurality of production lines simultaneously and identifies, in real time, a production line to which electrostatic protection failure has happened.

The present invention is disclosed in the preferred embodiments described above. However, persons skilled in the art should understand that the embodiments are provided to illustrate the present invention and should not be interpreted as being restrictive of the scope of the present invention. All equivalent modifications and variations can be made to the embodiments and still fall within the scope of the invention as set forth in the appended claims. Hence, the scope of protection for the present invention should be defined by the appended claims.

What is claimed is:

1. An electrostatic protection method for using in a production line, comprising steps of:
building a first electrostatic conductive element for connecting externally with a second electrostatic conductive element in the production line;
connecting the first electrostatic conductive element to a grounding end to form a first circuit for releasing static electricity from the first electrostatic conductive element;
connecting an alert device, the first electrostatic conductive element and the grounding end, wherein the alert device is provided therein with a second circuit for giving a failure warning of static electricity release failure; and
giving a feedback on the failure of the first electrostatic conductive element to release the static electricity through the first circuit to trigger the second circuit.

2. The method of claim 1, wherein the step of connecting the alert device further comprises the steps of:
providing the second circuit with a control unit for responding to the failure of the first circuit to release the static electricity, and triggering the second circuit;
providing the second circuit with an alert unit for giving a failure warning of static electricity release failure after the second circuit is triggered; and
providing the second circuit with a power supply unit for supplying electric power to the alert device.

3. An electrostatic protection device for using in a production line, comprising:
a first electrostatic conductive element connected to a grounding end and externally connected to at least a second electrostatic conductive element, wherein the first electrostatic conductive element and the grounding end are connected together to form a first circuit for releasing static electricity from the first electrostatic conductive element; and
an alert device electrically connected to the first electrostatic conductive element and the grounding end, and provided therein with a second circuit for being triggered to give a failure warning of static electricity release failure in response to a feedback on failure of the first electrostatic conductive element to release the static electricity.

4. The device of claim 3, wherein the alert device further comprises:
a control unit connected to the second circuit and configured to respond to static electricity release failure and trigger the second circuit;
an alert unit connected to the second circuit, and configured to give a failure warning of static electricity release failure; and
a power supply unit connected to the second circuit and configured to supply electric power to the alert device.

5. The device of claim 4, wherein the control unit comprises a three-terminal control element and a capacitor connected to a control end of the three-terminal control element.

6. An electrostatic protection device for using for a plurality of production lines, comprising:
a plurality of first electrostatic conductive elements corresponding in position to the production lines respectively, and connected to a grounding end, and externally connected to at least a second electrostatic conductive element, wherein each of the first electrostatic conductive elements and the grounding end are connected together to form a first circuit for releasing static electricity from the first electrostatic conductive elements; and
an alert device provided therein with a plurality of second circuits corresponding in position to the production lines respectively, wherein each of the second circuits, the corresponding first electrostatic conductive element and the grounding end are electrically connected together, in which the alert device gives a feedback on failure of releasing the static electricity from the corresponding first electrostatic conductive element in the corresponding production line, which is resulted in, triggering the corresponding second circuit to give a failure warning of static electricity release failure.

7. The device of claim 6, wherein the alert device further comprises:
a plurality of control units connected to the second circuits corresponding in position to the production lines respectively, and configured to respond to static electricity release failure on the corresponding production line resulting in triggering the second circuits;
a plurality of alert units connected to the second circuits corresponding in position to the production lines respectively, and configured to give a failure warning of static electricity release failure; and
a power supply unit connected to the second circuits corresponding in position to the production lines respectively, and configured to supply electric power to the alert device.

8. The device of claim 7, wherein each of the control units comprises a three-terminal control element and a capacitor connected to a control end of the three-terminal control element.
